(19) United States
(12) Patent Application Publication
(10) Pub. No.: US 2024/0291074 A1
(43) Pub. Date: Aug. 29, 2024

(54) ENERGY STORAGE DEVICE AND TEMPERATURE REGULATING STRUCTURE THEREOF

(71) Applicant: Sungrow Energy Storage Technology Co., Ltd., Hefei (CN)

(72) Inventors: Jinguo Su, Hefei (CN); Feng Pan, Hefei (CN)

(73) Assignee: Sungrow Energy Storage Technology Co., Ltd., Hefei (CN)

(21) Appl. No.: 18/570,619

(22) PCT Filed: Jun. 7, 2022
(86) PCT No.: PCT/CN2022/097282

§ 371 Date: Dec. 14, 2023

(30) Foreign Application Priority Data
Jul. 21, 2021 (CN) 202121668719.4

(51) Int. Cl. H01M 10/658; H01M 10/6554; H01M 50/244; H01M 50/262

(52) U.S. Cl. CPC H01M 10/658; H01M 10/6554; H01M 50/262; H01M 50/244

(57) ABSTRACT

An energy storage device and a temperature regulating structure thereof are provided in the present application. The temperature regulating structure of the energy storage device includes a housing and a temperature regulating plate fixedly connected to the housing, wherein the housing and the temperature regulating plate form a first heat insulation cavity, and/or the housing is provided with a second heat insulation cavity. In the temperature regulating structure of the energy storage device, the first heat insulation cavity is formed by the housing and the temperature regulating plate and/or the housing is provided with the second heat insulation cavity.

The present disclosure claims priority to Chinese Patent Disclosure No. 202121668719.4 titled “ENERGY STORAGE DEVICE AND TEMPERATURE REGULATING STRUCTURE THEREOF”, filed on Jul. 21, 2021 with the China National Intellectual Property Administration, which is incorporated herein by reference in its entirety.

### FIELD

The present disclosure relates to the technical field of cooling of energy storage batteries, and in particular to an energy storage device and a temperature regulating structure thereof.

### BACKGROUND

In a photovoltaic power generation system, an energy storage device is usually used to store excess energy. The energy storage device mainly includes an energy storage battery. In order to ensure normal operation, it is necessary to adjust the temperature of the energy storage battery.

At present, a liquid cooling plate is mainly used to cool and heat a battery cell of the energy storage battery. Specifically, the liquid cooling plate is fixed to a housing of the energy storage device, or the liquid cooling plate is integrated with the housing of the energy storage device. Heat or cold energy dissipated by the liquid cooling plate is easily transferred to an external environment through the housing, which affects the regulating efficiency of the liquid cooling plate. For example, in the case that the energy storage device is located in a low-temperature environment, if the battery cell is being heated, the heat dissipated by the liquid cooling plate is transferred to the external environment through the housing, resulting in a lower heating efficiency of the liquid cooling plate. In the case that the energy storage device is located in a high-temperature environment, if the battery cell is being cooled, the cold energy dissipated by the liquid cooling plate is transferred to the external environment through the housing, resulting in a lower cooling efficiency of the liquid cooling plate.

In summary, how to adjust the temperature of the energy storage battery to reduce the influence of the external environment and improve regulation efficiency is an urgent problem to be solved by those skilled in the art.

### SUMMARY

A temperature regulating structure of an energy storage device is provided according to the present disclosure to reduce the influence of the external environment and improve regulation efficiency. Another object of the present disclosure is to provide an energy storage device including the above temperature regulating structure.

In order to achieve the above objects, the present disclosure provides the following technical solutions:

A temperature regulating structure of an energy storage device includes a housing and a temperature regulating plate fixedly connected to the housing. The housing and the temperature regulating plate form a first thermal insulation cavity, and/or a second thermal insulation cavity is formed by the housing.

In an embodiment, the housing includes an interior plate and an exterior plate, the temperature regulating plate is fixedly connected to the interior plate, and the second thermal insulation cavity is arranged between the interior plate and the exterior plate.

In an embodiment, the housing further includes a reinforcing member fixed in the second thermal insulation cavity, and the reinforcing member separates the second thermal insulation cavity into at least two sub-cavities.

In an embodiment, one end of the reinforcing member is fixedly connected to the exterior plate, and the other end of the reinforcing member is fixedly connected to the interior plate.

In an embodiment, the interior plate and the exterior plate are integrated formed.

In an embodiment, the temperature regulating plate is provided with a first thermal insulation groove, and the housing and the first thermal insulation groove form the first thermal insulation cavity.

In an embodiment, the temperature regulating plate includes a first plate and a second plate arranged in parallel, and the first plate and the second plate form a temperature regulating cavity for the circulation of a temperature regulating medium. The second plate is closer to the housing than the first plate, the second plate is provided with a first protrusion, the first protrusion protrudes towards the first plate and forms the first thermal insulation groove, and the first protrusion is fixedly and sealingly connected to the first plate.

In an embodiment, the housing is provided with a second thermal insulation groove, and the temperature regulating plate and the second thermal insulation groove form the first thermal insulation cavity.

In an embodiment, the temperature regulating plate is fixed to a bottom housing plate of the housing. The bottom housing plate is provided with a support structure that supports the temperature regulating plate, and the support structure protrudes from an interior wall of the bottom housing plate.

In an embodiment, the temperature regulating plate is provided with a support groove, and the support structure is arranged in the support groove to support the temperature regulating plate.

In an embodiment, the temperature regulating plate includes a first plate and a second plate arranged in parallel, and the first plate and the second plate form a temperature regulating cavity, in which the circulation of a temperature regulating medium is made. The second plate is positioned closer to the housing than the first plate, the second plate is provided with a second protrusion, the second protrusion protrudes towards the first plate and forms the support groove, and the second protrusion is fixedly and sealingly connected to the first plate.

In an embodiment, a portion, supported by the support structure, of the temperature regulating plate is defined as a supported portion, the supported portion and the supporting structure are arranged in one-to-one correspondence, and at least two battery cells are located at the same supported portion.

In an embodiment, the support structure is in a hollow structure.

In an embodiment, the temperature regulating structure of an energy storage device further includes: a connecting member fixed to the housing, and a support beam fixedly connected to the connecting member. The supporting beam supports the temperature regulating plate.

In an embodiment, in a case that the second thermal insulation cavity is formed by the housing, the housing plate, which formed the second thermal insulation cavity, of the housing is formed by extrusion molding;
in a case that the housing and the temperature regulating plate form the first thermal insulation cavity and there is no the second thermal insulation cavity formed in the housing, the housing is a die-cast housing.

Based on the temperature regulating structure of an energy storage device described above, an energy storage device is also provided according to the present application. The energy storage device includes the temperature regulating structure described above.

According to the temperature regulating structure of an energy storage device provided in the present application, the first thermal insulation cavity is formed by the housing and the temperature regulating plate, and/or the second thermal insulation cavity is formed by the housing. The first thermal insulation cavity and the second thermal insulation cavity are provided to reduce the heat exchange between the temperature regulating plate and the outside through the housing, thereby reducing the influence of the external environment on the temperature regulating plate and improving the regulating efficiency of the temperature regulating plate.

### BRIEF DESCRIPTION OF THE DRAWINGS

In order to more clearly illustrate the technical solutions in the embodiments of the present disclosure or in the conventional technology, the drawings required in the description of the embodiments or the conventional technology will be briefly introduced below.

Apparently, the drawings in the following description are only part of the embodiments of the present application. For those skilled in the art, other drawings may also be obtained based on the structures shown in these drawings without creative efforts.

FIG. 1 is a schematic structural view of a temperature regulating structure of an energy storage device according to an embodiment of the present application;

FIG. 2 is an enlarged schematic view of Part A in FIG. 1;

FIG. 3 is an enlarged schematic view of Part B in FIG. 1;

FIG. 4 is a partial schematic structural view of a temperature regulating plate in FIG. 1;

FIG. 5 is another schematic structural view of a temperature regulating structure of an energy storage device according to an embodiment of the present application;

FIG. 6 is an enlarged schematic view of Part C in FIG. 5;

FIG. 7 is a partial schematic structural view of a housing in FIG. 5; and

FIG. 8 is a partial schematic structural view of a temperature regulating plate in FIG. 5.

### DETAILED DESCRIPTION OF EMBODIMENTS

The technical solutions in the embodiments of the present disclosure are clearly and completely described below in conjunction with the drawings. Apparently, the described embodiments are only part of the embodiments of the present application, not all of the embodiments of the present application. Any other embodiment obtained by those skilled in the art based on the embodiments in the present disclosure without creative efforts shall fall within the protection scope of the present application.

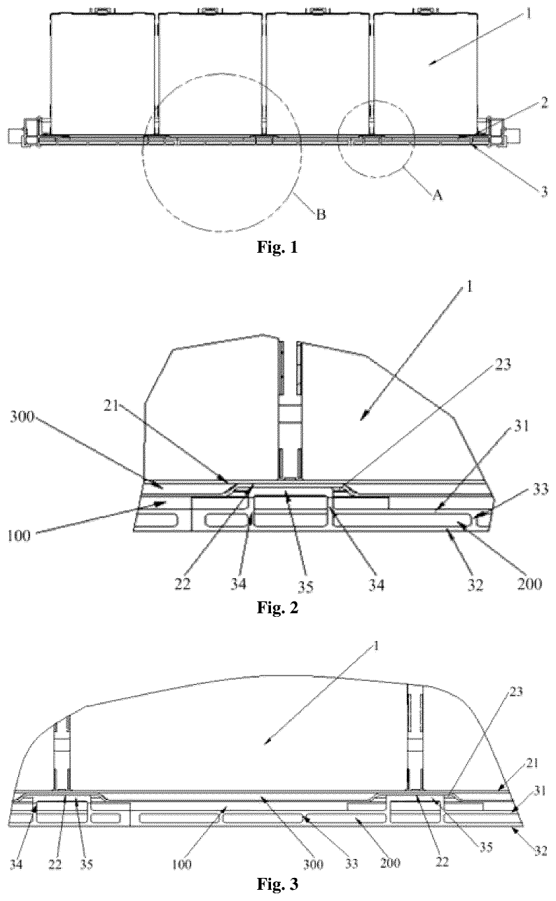

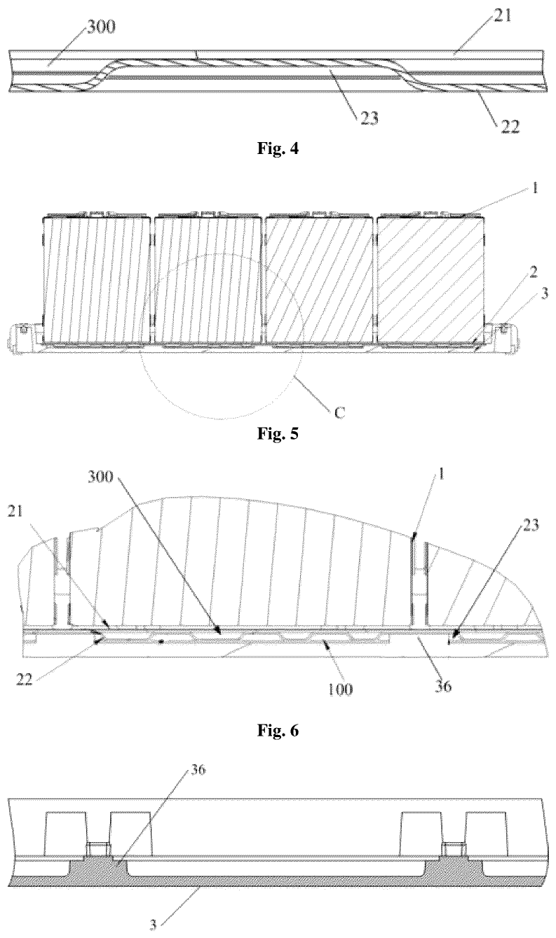

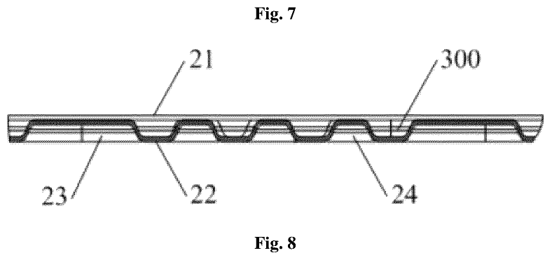

As shown in FIGS. 1 to 8, a temperature regulating structure of an energy storage device according to an embodiment of the present disclosure includes: a housing 3 and a temperature regulating plate 2 fixedly connected to the housing 3. The housing 3 and the temperature regulating plate 2 form a first thermal insulation cavity 100, and/or the housing 3 has a second thermal insulation cavity 200.

It should be noted that the temperature regulating plate 2 is configured to be thermally connected to a battery cell 1 to ensure that the temperature regulating plate 2 can adjust the temperature of the battery cell 1. The temperature regulating plate 2 may be configured to heat the battery cell 1, or may be configured to cool and heat the battery cell 1, which can be selected according to actual requirements. The type of the temperature regulating plate 2 is selected according to actual requirements. For example, the temperature regulating plate 2 is a liquid cooling plate, which can heat the battery cell 1 or cool the battery cell 1.

It can be understood that the second thermal insulation cavity 200 and the temperature regulating plate 2 are located on a same housing plate of the housing 3, that is, the second thermal insulation cavity 200 and the temperature regulating plate 2 are located on the same side of the battery cell 1. For example, the second thermal insulation cavity 200 and the temperature regulating plate 2 are located on a bottom housing plate of the housing 3. It should be noted that the bottom housing plate is located at a bottom end of the housing 3.

According to the temperature regulating structure of an energy storage device provided by the embodiments of the present application, the first thermal insulation cavity 100 is formed by the housing 3 and the temperature regulating plate 2, and/or the housing 3 has the second thermal insulation cavity 200. The first thermal insulation cavity 100 and the second thermal insulation cavity 200 can be used to reduce the heat exchange between the temperature regulating plate 2 and the outside through the housing 3, thereby reducing the influence of the external environment on the temperature regulating plate 2 and improving the regulating efficiency of the temperature regulating plate 2.

The number of the first thermal insulation cavities 100 may be one, two or more, and the number of the second thermal insulation cavities 200 may be one, two or more. In order to improve the thermal insulation effect, the number of the first thermal insulation cavities 100 may be two or more, and the number of the second thermal insulation cavities 200 may be two or more.

The sizes and shapes of the first thermal insulation cavity 100 and the second thermal insulation cavity 200 are selected according to actual requirements, which is not limited in the embodiment.

In the temperature regulating structure of an energy storage device, in case that the housing 3 has the second thermal insulation cavity 200, the structure of the housing 3 is designed according to actual requirements. Specifically, the housing 3 includes an interior plate 31 and an exterior plate 32. The temperature regulating plate 2 is fixedly connected to the interior plate 31. The second thermal insulation cavity 200 is formed between the interior plate 31 and the exterior plate 32.

It can be understood that the exterior plate 32 is located on an outer side of the housing 3, and the interior plate 31 is located on an inner side of the housing 3. That is, an exterior wall of the exterior plate 32 is the outer side of the housing 3, and an interior wall of the interior plate 31 is an exterior wall of the housing 3. The housing 3 includes the interior plate 31 and the exterior plate 32, and at least one of housing plates of the housing 3 includes the interior plate 31 and the exterior plate 32.

The housing 3 is in a hollow structure. In order to ensure the strength of the housing 3, the housing 3 further includes multiple reinforcing members 33 fixed to the second thermal insulation cavity 200. The reinforcing member 33 separates the second thermal insulation cavity 200 into at least two sub-cavities.

In the housing 3, the interior plate 31 and the exterior plate 32 are two separate parts, or the interior plate 31 and the exterior plate 32 are integrated. In order to facilitate production and simplify assembly, the interior plate 31 and the exterior plate 32 may be in an integrated structure.

In order to improve the reinforcing effect, one end of the reinforcing member 33 is fixedly connected to the exterior plate 32, and the other end of the reinforcing member 33 is fixedly connected to the interior plate 31.

In practical application, the reinforcing member 33 may be arranged in other ways. For example, both ends of the reinforcing member 33 are fixedly connected to the exterior plate 32, which is not limited to the above embodiment.

The shape and the number of the reinforcing members 33 may be selected according to actual requirements. For example, the reinforcing member 33 is a reinforcing plate or reinforcing rib, the number of the reinforcing members 33 may be one, two or more, which is not limited in the embodiment.

In order to facilitate production and simplify installation, the interior plate 31, the exterior plate 32, and the reinforcing member 33 may be in an integrated structure.

Alternatively, at least two among the interior plate 31, the exterior plate 32, and the reinforcing member 33 may be separate parts, which is not limited to the above embodiments.

In the temperature regulating structure of an energy storage device, in case that the first thermal insulation cavity 100 is formed by the housing 3 and the temperature regulating plate 2, in order to facilitate the formation of the first thermal insulation cavity 100, the temperature regulating plate 2 may be provided with a first thermal insulation groove 24, and the first thermal insulation cavity 100 is formed by the housing 3 and the first thermal insulation groove 24.

Specifically, the temperature regulating plate 2 comprises a first plate 21 and a second plate 22 that are arranged in parallel. The first plate 21 and the second plate 22 form a temperature regulating cavity 300 for the circulation of a temperature regulating medium. The second plate 22 is closer to the housing 3 than the first plate 21, and the second plate 22 has a first protrusion. The first protrusion protrudes towards the first plate 21 and forms the first thermal insulation groove 24. The first protrusion is fixedly and sealingly connected to the first plate 21.

In order to facilitate the arrangement of the first protrusion, the second plate 22 may form the first protrusion by stamping or other processes, which is not limited to the embodiment.

In practical application, the first protrusion may not be provided, and the first thermal insulation groove 24 may be directly provided on the second plate 22, which is not limited to the above embodiments.

In order to facilitate the arrangement of the first protrusion, the second plate 22 may form the first protrusion by stamping or other processes.

The specific structure of the temperature regulating plate 2 is selected according to actual requirements, which is not limited to the above embodiments.

In practical application, the housing 3 may also be provided with a second thermal insulation groove. The temperature regulating plate 2 and the second thermal insulation groove form the first thermal insulation cavity 100. Specifically, in case that the housing 3 includes the interior plate 31 and the exterior plate 32 and the temperature regulating plate 2 is fixedly connected to the interior plate 31, the interior plate 31 may be provided with a recessed portion. The recessed portion is recessed towards the exterior plate 32 to form the second thermal insulation groove.

In the temperature regulating structure of an energy storage device, the temperature regulating plate 2 may be also provided with the first thermal insulation groove 24, the housing 3 may be also provided with second thermal insulation groove, and the second thermal insulation groove and the first thermal insulation groove 24 are joined to form the first thermal insulation cavity 100, which is not limited to the above two situations.

In the temperature regulating structure of an energy storage device, the temperature regulating plate 2 may be fixed to the bottom of the housing 3, or may be fixed to a side portion of the housing 3. In order to facilitate of cooling of the battery cell 1, the former is preferred, that is, the temperature regulating plate 2 is fixed to the bottom housing plate of the housing 3. It can be understood that the bottom housing plate is located at the bottom of the housing 3.

In that case, the temperature regulating plate 2 bears a part of the weight of the battery cell 1, so that the temperature regulating plate 2 is easily damaged, and the service life of the temperature regulating plate 2 is affected. In order to solve the above problem, the bottom housing plate may be provided with a support structure 36 for supporting the temperature regulating plate 2. The support structure 36 protrudes from an interior wall of the bottom housing plate.

In the above structure, the temperature regulating plate 2 is supported by the support structure 36, so that the weight of the battery cell 1 can be exerted on the entire housing 3. The temperature regulating plate 2 is not required to bear the weight of the battery cell 1, which reduces the risk that the temperature regulating plate 2 is broken by the battery cell 1, thereby prolonging the service life of the temperature regulating plate 2.

The number, shape, and size of the support structure 36 are selected according to actual requirements, which is not limited in the embodiment.

In order to make the temperature regulating plate 2 not bear the weight, the temperature regulating plate 2 may be provided with a support groove 23, and the support structure 36 is arranged in the support groove 23 to support the temperature regulating plate 2.

In order to improve the effect, the support groove 23 and the support structure 36 may be arranged to be in one-to-one correspondence. Alternatively, the support groove 23 and the support structure 36 may also have other corresponding relationships, which is not limited in the embodiment.

In the temperature regulating structure of an energy storage device, in order to facilitate the formation of the support groove 23, the temperature regulating plate 2 comprises a first plate 21 and a second plate 22 arranged in parallel. The first plate 21 and the second plate 22 form a temperature regulating cavity 300 for the circulation of the temperature regulating medium. The second plate 22 is closer to the housing 3 than the first plate 21, and the second plate 22 has a second protrusion. The second protrusion protrudes towards the first plate 21 and forms a support groove 23. The second protrusion is fixedly and sealingly connected to the first plate 21.

In order to facilitate the arrangement of the second protrusion, the second plate 22 may form the second protrusion by stamping or other processes.

In practical application, in case that the temperature regulating plate 2 is provided with the support groove 23 and the first thermal insulation groove 24, the support groove 23 and the first thermal insulation groove 24 may be arranged in parallel. The number of the first thermal insulation grooves 24 between two adjacent support grooves 23 may be one, two or more. As shown in FIG. 8, the number of the first thermal insulation grooves 24 between two adjacent support grooves 23 is three.

The shapes of the first thermal insulation groove 24 and the support groove 23 may be the same or different, and the sizes of the first thermal insulation groove 24 and the support groove 23 may be the same or different, which are selected according to actual requirements and not limited in the embodiment.

The specific structure of the temperature regulating plate 2 is selected according to actual requirements, which is not limited to the above embodiments.

In order to simplify the structure, a portion, supported by the support structure 36, of the temperature regulating plate 2 is defined as a supported portion. The supported portion and the support structure 36 are arranged in one-to-one correspondence. At least two battery cells 1 are arranged on the same supported portion.

It can be understood that at least one supported portion can bear the weight of at least two battery cells 1.

The supporting structure 36 may be in a solid structure, or may be in a hollow structure. In order to reduce the weight of the housing 3, the supporting structure 36 is in a hollow structure. Specifically, the supporting structure includes: a connecting member 34 fixed to the housing 3, and a supporting beam 35 fixedly connected to the connecting member 34. The support beam 35 supports the temperature regulating plate 2.

In case that the housing 3 includes an exterior plate 32 and an interior plate 31, one end of the connecting member 34 is fixedly connected to the support beam 35, and the other end of the connecting member 34 is fixedly connected to the exterior plate 32 of the housing 3. The connecting member 34 extends through the interior plate 31 of the housing 3.

In practical applications, one end of the connecting member 34 may also be fixedly connected to the interior plate 31 of the housing 3, and the connecting member 34 is not required to pass through the interior plate 31.

In the temperature regulating structure of an energy storage device, in case that the housing 3 is provided with the second thermal insulation cavity 200, in order to facilitate production and manufacturing, a housing plate, which is provided with the second thermal insulation cavity 200, of the housing 3 may be formed by extrusion molding. For example, the bottom housing plate, which is provided with the second thermal insulation cavity 200, is formed by extrusion molding, and other housing plates are not limited. Alternatively, the housing plate with the second thermal insulation cavity 200 may also be formed in other way, which is not limited in the embodiment.

In the temperature regulating structure of an energy storage device, in case that the housing 3 and the temperature regulating plate 2 form the first thermal insulation cavity 100 and the housing 3 is not provided with the second thermal insulation cavity 200, in order to facilitate production and manufacturing, the housing 3 may be a die-cast housing. Alternatively, the housing 3 may also be in other types, which is not limited in the embodiment.

In the temperature regulating structure of an energy storage device, in order to facilitate of fixing the housing 3 with the temperature regulating plate 2, the housing 3 and the temperature regulating plate 2 may be fixedly connected by welding. Alternatively, the temperature regulating plate 2 may also be bonded to the housing 3, which is not limited in the embodiment.

In the temperature regulating structure of an energy storage device, in order to improve the effect of the temperature regulating plate 2, a thermal-conductive insulation layer may be filled between the battery cell 1 and the liquid cooling plate 2. The specific structure and the material of the thermal-conductive insulation layer may be selected according to actual requirements, which is not limited in the embodiment.

In the temperature regulating plate 2, the first plate 21 and the second plate 22 are fixedly connected by brazing, or the first plate 21 and the second plate 22 are fixedly connected by hot rolling. Alternatively, the temperature regulating plate 2 may be in other structures, which is not limited in the embodiment.

In order to more specifically illustrate the temperature regulating structure of an energy storage device according to the embodiment, two embodiments are provided below for explanation.

### Embodiment 1

As shown in FIGS. 1 to 4, a temperature regulating structure of an energy storage device according to Embodiment 1 includes: a housing 3, a temperature regulating plate 2 fixedly connected to a bottom of the housing 3. The housing 3 is provided with a second thermal insulation groove. The temperature regulating plate 2 and the second thermal insulation groove form a first thermal insulation cavity 100, and the housing 3 is provided with a second insulation cavity 200.

Specifically, the temperature regulating plate 2 is fixedly connected to a bottom housing plate of the housing 3. The second thermal insulation groove is formed at the bottom housing plate, and the bottom housing plate is provided with the second insulation cavity 200.

In Embodiment 1, the temperature regulating plate 2 is provided with a support groove 23, and the bottom housing plate is provided with a support structure 36 that supports the temperature regulating plate 2. The support structure 36 protrudes from an interior wall of the bottom housing plate, and the support structure 36 is arranged in the support groove 23 to support the temperature regulating plate 2. Specifically, the support groove 23 and the support structure 36 are arranged in one-to-one correspondence.

### Embodiment 2

As shown in FIGS. 5 to 8, a temperature regulating structure of an energy storage device according to Embodiment 2 includes: a housing 3, a temperature regulating plate 2 fixedly connected to a bottom of the housing 3. The temperature regulating plate 2 is provided with a first thermal insulation groove 24, and the housing 3 and the first thermal insulation groove 24 form a first thermal insulation cavity 100.

Specifically, the temperature regulating plate 2 is fixedly connected to a bottom housing plate of the housing 3, and the bottom housing plate and the first thermal insulation groove 24 form the first thermal insulation cavity 100.

In Embodiment 2, the temperature regulating plate 2 is provided with a support groove 23, and the bottom housing plate is provided with a support structure 36 that supports the temperature regulating plate 2. The support structure 36 protrudes from an interior wall of the bottom housing plate, and the support structure 36 is arranged in the support groove 23 to support the temperature regulating plate 2. Specifically, the support groove 23 and the support structure 36 are arranged in one-to-one correspondence.

Based on the temperature regulating structure of an energy storage device according to the above embodiments, an energy storage device is further provided according to the embodiments. The energy storage device includes the temperature regulating structure of an energy storage device as described above.

Since the temperature regulating structure of the energy storage device according to the embodiments has the above technical effects, and the energy storage device includes the temperature regulating structure of an energy storage device, and thus the energy storage device also has the corresponding technical effects, which is not repeated herein.

The above description of the embodiments is provided to enable those skilled in the art to implement or use the present application. Various modifications to the embodiments are apparent to those skilled in the art. General principles defined herein may be implemented in other embodiments without departing from spirits or scopes of the present application. Therefore, the present disclosure is not limited to the embodiments shown herein, but is to be accorded the widest scope consistent with the principles and novel features disclosed herein.

1. A temperature regulating structure of an energy storage device, comprising a housing and a temperature regulating plate fixedly connected to the housing, wherein
the housing and the temperature regulating plate form a first thermal insulation cavity, and/or a second thermal insulation cavity is formed by the housing.

2. The temperature regulating structure according to claim 1, wherein the housing comprises an interior plate and an exterior plate, the temperature regulating plate is fixedly connected to the interior plate, and the second thermal insulation cavity is arranged between the interior plate and the exterior plate.

3. The temperature regulating structure according to claim 2, wherein the housing further comprises a reinforcing member fixed in the second thermal insulation cavity, and the reinforcing member separates the second thermal insulation cavity into at least two sub-cavities.

4. The temperature regulating structure according to claim 3, wherein one end of the reinforcing member is fixedly connected to the exterior plate, and the other end of the reinforcing member is fixedly connected to the interior plate.

5. The temperature regulating structure according to claim 2, wherein the interior plate and the exterior plate are integrated formed.

6. The temperature regulating structure according to claim 1, wherein the temperature regulating plate is provided with a first thermal insulation groove, and the housing and the first thermal insulation groove form the first thermal insulation cavity.

7. The temperature regulating structure according to claim 6, wherein the temperature regulating plate comprises a first plate and a second plate arranged in parallel, and the first plate and the second plate form a temperature regulating cavity for the circulation of a temperature regulating medium, wherein the second plate is positioned closer to the housing than the first plate, the second plate is provided with a first protrusion, the first protrusion protrudes towards the first plate and forms the first thermal insulation groove, and the first protrusion is fixedly and sealingly connected to the first plate.

8. The temperature regulating structure according to claim 1, wherein the housing is provided with a second thermal insulation groove, and the temperature regulating plate and the second thermal insulation groove form the first thermal insulation cavity.

9. The temperature regulating structure according to claim 1, wherein the temperature regulating plate is fixed to a bottom housing plate of the housing, the bottom housing plate is provided with a support structure that supports the temperature regulating plate, and the support structure protrudes from an interior wall of the bottom housing plate.

10. The temperature regulating structure according to claim 9, wherein the temperature regulating plate is provided with a support groove, and the support structure is arranged in the support groove to support the temperature regulating plate.

11. The temperature regulating structure according to claim 10, wherein the temperature regulating plate comprises a first plate and a second plate arranged in parallel, and the first plate and the second plate form a temperature regulating cavity, in which a circulation of a temperature regulating medium is made, and the second plate is positioned closer to the housing than the first plate,
wherein the second plate is provided with a second protrusion, which is protrudes towards the first plate and forms the support groove, and the second protrusion is fixedly and sealingly connected to the first plate.

12. The temperature regulating structure according to claim 9, wherein a portion, supported by the supporting structure, of the temperature regulating plate is defined as a supported portion, the supported portion and the supporting structure are arranged in one-to-one correspondence, and at least two battery cells are located on the same supported portion.

13. The temperature regulating structure according to claim 9, wherein the supporting structure is in a hollow structure.

14. The temperature regulating structure according to claim 13, further comprising a connecting member fixed to the housing and a support beam fixedly connected to the connecting member, wherein the supporting beam supports the temperature regulating plate.

15. The temperature regulating structure according to claim 1, wherein
the second thermal insulation cavity is formed by the housing, and a housing plate, which forms the second thermal insulation cavity, of the housing is formed by extrusion molding, or
the housing and the temperature regulating plate form the first thermal insulation cavity and there is no the second thermal insulation cavity formed in the housing, the housing is a die-cast housing.

16. An energy storage device, comprising the temperature regulating structure according to claim 1.
